(19) United States
(12) Patent Application Publication
(10) Pub. No.: US 2011/0276313 A1
(43) Pub. Date: Nov. 10, 2011

(54) RECORDING SYSTEM, IN-VEHICLE APPARATUS, AND PORTABLE TERMINAL

(75) Inventor: Ichirou INABA, Nagoya-city (JP)

(73) Assignee: DENSO CORPORATION, Kariya-city (JP)

(21) Appl. No.: 13/094,132

(22) Filed: Apr. 26, 2011

(30) Foreign Application Priority Data
May 10, 2010 (JP) 2010-108266

(51) Int. Cl. G06F 17/40

(52) U.S. Cl. 702/187

(57) ABSTRACT

An in-vehicle apparatus is connected with a portable terminal to enable communications. The in-vehicle apparatus then acquires an ID code of the portable terminal and opens a log file corresponding to the ID code, registering a record describing a vehicle compartment environment, etc. When the vehicle compartment is under an abnormal environment (high temperature, high humidity, or strong vibration environment), a record describing a duration of the abnormal environment is registered in the log file. In addition, when an operation anomaly occurs in the portable terminal or the vehicle compartment is under the abnormal environment, a record describing an operation state of the portable terminal is registered in the log file. Furthermore, when the connection between the portable terminal and the in-vehicle apparatus is released, a record describing a duration of the connection is registered in the log file.

### CROSS REFERENCE TO RELATED APPLICATION

The present application is based on and incorporates herein by reference Japanese Patent Application No. 2010-108266 filed on May 10, 2010.

### FIELD OF THE INVENTION

The present invention relates to a recording system to record a specific type of data, and further relates to an in-vehicle apparatus and a portable terminal, which are included in the recording system.

### BACKGROUND OF THE INVENTION

[Patent Document 1] JP 2002-228553 A (US 2002/0103582 A1)

A portable information device (referred to as a portable terminal) such as a cellular phone is equipped with various functions, which include a notebook function, a music reproduction function, and a game function. The portable terminal is becoming a tool indispensable for a daily life. Such a portable terminal is typically carried by a user in many cases, and is used in various environments depending on user's movement.

Furthermore, in recent years, it is considered to combine functions of a portable terminal and an in-vehicle apparatus so as to provide a user with a function having a high convenience in a vehicle. The user may be provided with the function which downloads data for the in-vehicle apparatus via the wireless communications function of the portable terminal, and the function which outputs music which the portable terminal plays from an in-vehicle speaker, for instance.

In contrast, there is known an in-vehicle apparatus having the function that downloads from a center server a program to search for trouble causes, executes the program to obtain a search result, and transmits the search result to the center server. Such an in-vehicle apparatus enables a remote diagnose that trouble causes are diagnosed from a center server remotely (for example, refer to Patent document 1).

The portable terminal is carried and is used in various environments. It may break down easily as compared with a non-portable device. The exposure against a severe environment noncompliant with a specification of the portable terminal may result in a breakdown or damage frequently as compared with a non-portable device. A currently available portable terminal is designed for a user to always carry. A use of the portable terminal in a vehicle may result in a breakdown because of a severe environment peculiar to the vehicle. In contrast, there is not fully developed a technology for specifying a breakdown cause of the portable terminal. Even if a portable terminal breaks down because of the use under severe environment, it is not easy to specify the breakdown cause from the portable terminal itself after breaking down.

Therefore, a warranty service for the portable terminal is not fully established at present. There is not presently provided a warranty service which satisfies a user. In addition, it is not easy to specify a breakdown cause; thus, breakdown information cannot fully be used for the development of the portable terminal. That is, at present, breakdown information useful for the development is not provided to the needs for developing in low costs a portable terminal durable against an environment of a vehicle compartment of a vehicle (also referred to as a vehicle compartment environment) based on the breakdown information.

### SUMMARY OF THE INVENTION

The present invention is made in view of the above problem. It is an object of the present invention to provide a recoding system which provides useful information to specify a failure cause of a portable terminal, and a portable terminal and an in-vehicle apparatus which is included in the recording system.

To achieve the above object, according to an example of the present invention, a recording system including a portable terminal and an in-vehicle apparatus is provided as follows. The portable terminal is a portable information apparatus; and the in-vehicle apparatus is mounted in a vehicle and includes a measurement data acquisition section to acquire measurement data indicating a measurement result of a physical quantity measured by a measurement instrument, the physical quantity being relative to a vehicle compartment environment of the vehicle, the vehicle compartment environment varying over time. The portable terminal and the in-vehicle apparatus respectively include communications devices which communicate with each other. At least one of the portable terminal and the in-vehicle apparatus includes a storage media and an output section. The storage media stores data indicating the vehicle compartment environment; the output section outputs the vehicle compartment environment data stored in the storage media. At least one of the portable terminal and the in-vehicle apparatus includes a write control section configured to write data indicating the vehicle compartment environment under a communications state, where the portable device and the in-vehicle apparatus are connected to enable communications, based on the measurement data acquired by the measurement data acquisition section, with an onset of connection between the portable terminal and the in-vehicle apparatus to enable the communications state via the communications devices.

It is noted that the communications device only need enable the communications between the portable terminal and the in-vehicle apparatus in the vehicle compartment; thus, it may be either wired communications means or wireless communications means (i.e., short range wireless communications).

Under the above configuration, with an onset of connection between the portable terminal and the in-vehicle apparatus to enable communications via the communications devices, the data indicating an environment of a vehicle compartment is recorded or stored in a storage media. Thus, almost after the portable terminal is brought into the occupant compartment of the vehicle, the writing into the storage media is started with respect to the data of the vehicle compartment environment. Moreover, the recorded vehicle compartment environment data is outputted as needed, to a display device, a failure diagnosis instrument, etc.

Therefore, the recording system can accumulate in the storage media useful information (indicating the vehicle compartment environment) for specifying the cause of an anomaly of the portable terminal which results from the vehicle compartment environment, and provides users with the recorded and accumulated information. That is, according to the above configuration of the recording system, based on the data indicating the vehicle compartment environment obtained via the output means or device, users can analyze in what kind of environment the portable terminal is used inside of the vehicle compartment. This is useful for specifying the failure or anomaly of the portable terminal resulting from the vehicle compartment environment. Therefore, the above recording system can assist the development of warranty service of the portable terminal and the development to enable the portable terminal to be sufficiently durable against the vehicle compartment environment.

As another example of the present invention, an in-vehicle apparatus mounted in a vehicle is provided as follows. A storage media is included. A communications device is configured to connect with a portable terminal in a vehicle compartment of the vehicle to enable wired or wireless communications. A measurement data acquisition section is configured to acquire measurement data indicating a measurement result of a physical quantity measured by a measurement instrument, the physical quantity being relative to the vehicle compartment environment that varies over time. A write control section is configured to write in the storage media data indicating the vehicle compartment environment under a communications state of connecting with the portable terminal to enable communications based on the measurement data acquired by the measurement data acquisition section with an onset of connection with the portable terminal via the communications device. An output section is configured to output data indicating the vehicle compartment environment stored in the storage media.

As yet another example of the present invention, a portable terminal cooperating an in-vehicle apparatus mounted in a vehicle is provided as follows. A communications device is configured to establish in a vehicle compartment of the vehicle a communications state of connecting with the in-vehicle apparatus to enable wired or wireless communications. A write control section is configured to (i) acquire, from the in-vehicle apparatus, measurement data indicating a measurement result of a physical quantity measured by a measurement instrument, the physical quantity being relative to a vehicle compartment environment that varies over time, via the communications device with an onset of the communications state of connecting with the in-vehicle apparatus via the communications device, and (ii) write, based on the acquired measurement data, data indicating a vehicle compartment environment under the communications state of connecting with the in-vehicle apparatus in the storage media. An output section is configured to output data indicating the vehicle compartment environment stored in the storage media.

### BRIEF DESCRIPTION OF THE DRAWINGS

The above and other objects, features, and advantages of the present invention will become more apparent from the following detailed description made with reference to the accompanying drawings. In the drawings:

FIGS. 1A, 1B are diagrams illustrating examples of connections between a portable terminal and an in-vehicle apparatus;

FIG. 2 is a block diagram illustrating configurations of a portable terminal and an in-vehicle apparatus;

FIG. 3 is a flowchart diagram illustrating a primary recording process;

FIG. 4 is a flowchart diagram illustrating a temperature information write control process;

FIG. 5 is a flowchart diagram illustrating a humidity information write control process;

FIG. 6 is a flowchart diagram illustrating a vibration information write control process;

FIG. 7 is a flowchart diagram illustrating a position information write control process;

FIG. 8 is a flowchart diagram illustrating an operation state write control process;

FIG. 9 is a flowchart diagram illustrating a secondary recording process;

FIG. 10A is a flowchart diagram illustrating an output process executed by the in-vehicle apparatus; and

FIG. 10B is a flowchart diagram illustrating an output process executed by the portable terminal.

### DETAILED DESCRIPTION OF THE PREFERRED EMBODIMENTS

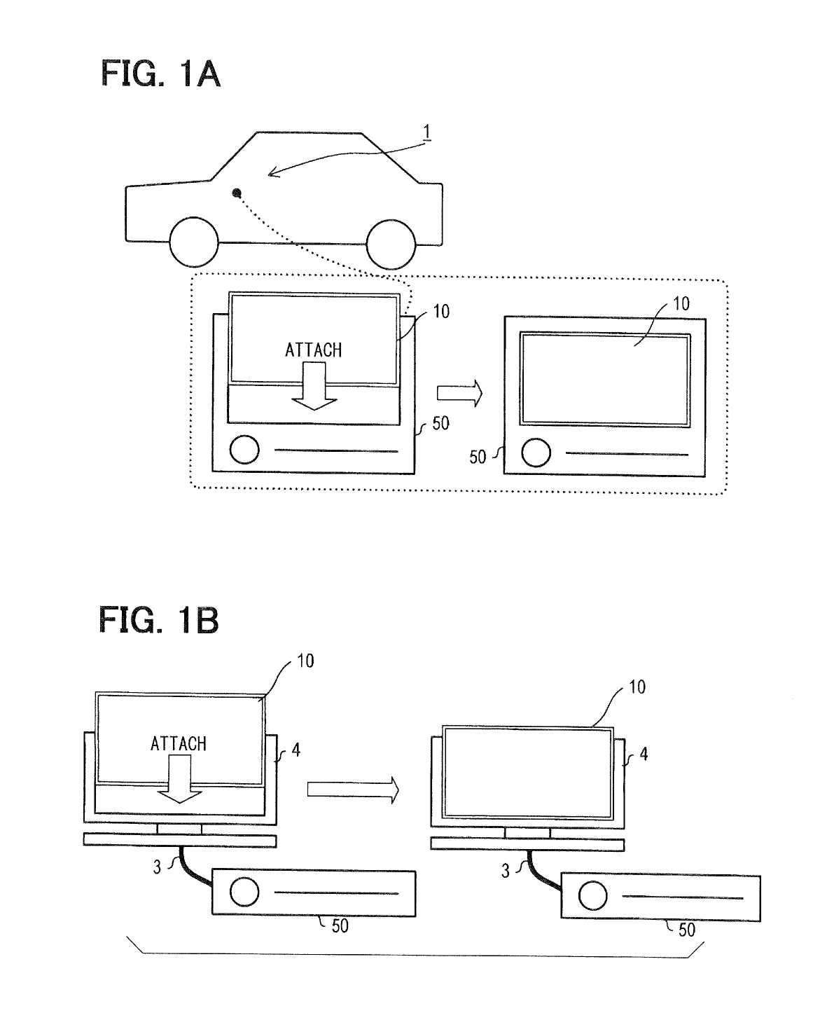

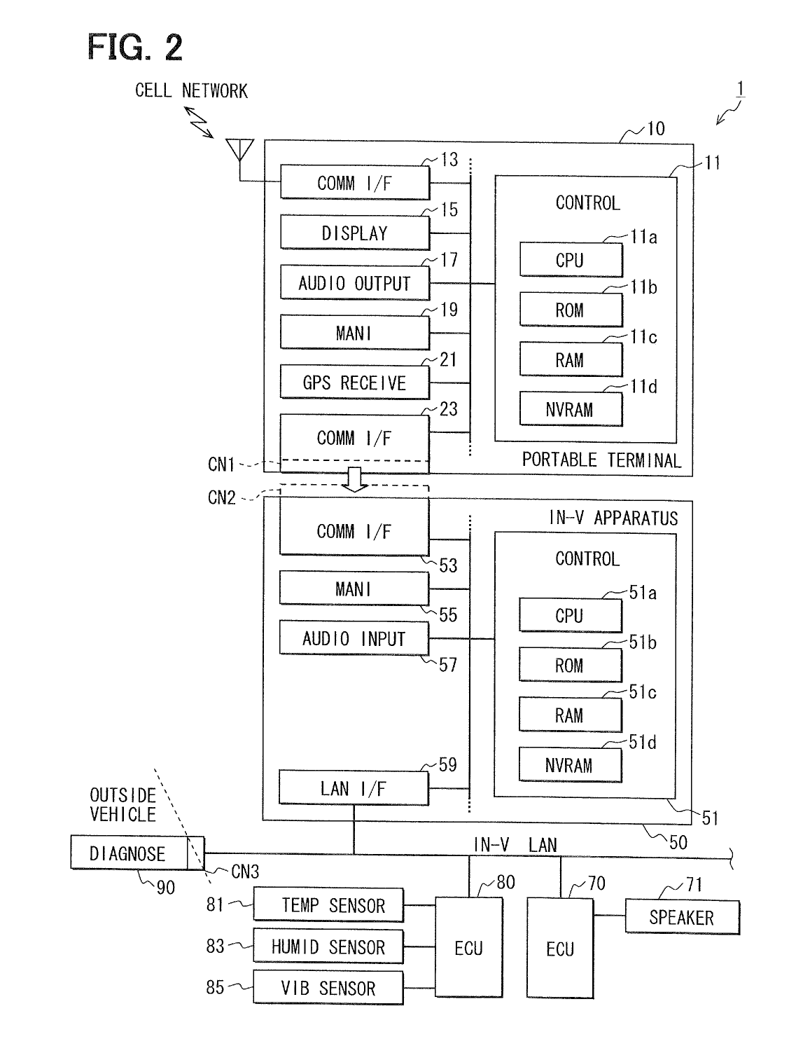

Hereafter, description will be given to embodiments of the present invention with reference to the drawings. The recording system 1 of the present embodiment includes a portable terminal 10 and an in-vehicle apparatus 50 that is fixedly arranged in a vehicle, as illustrated in FIGS. 1A, 1B, 2. For example, as illustrated in FIG. 1A, the portable terminal 10 is attached to the in-vehicle apparatus 50 and connected with the in-vehicle apparatus 50 for wire communications. Alternatively, as illustrated in FIG. 1B, the portable terminal 10 may be attached to a cradle 4 arranged at an end of a cable 3 extended from the in-vehicle apparatus 50, and, thereby, connected with the in-vehicle apparatus 50 to enable wired communications. The following explains the recording system 1 in which the portable terminal 10 and the in-vehicle apparatus 50 are connected with each other to enable wired communications. However, in the recording system 1, the portable terminal 10 and the in-vehicle apparatus 50 may connect with each other to enable wireless communications. For example, in the recording system 1, the portable terminal 10 and the in-vehicle apparatus 50 may communicate with each other in the vehicle by short range wireless communications connection such as Bluetooth (registered trademark).

Next, the configurations of the portable terminal 10 and the in-vehicle apparatus 50 are explained with reference to FIG. 2. The portable terminal 10 according to the present embodiment is a portable information device equipped with a telephone function, a music reproduction function, a route guide function (navigation function), etc. The portable terminal 10 includes the following: a control circuit 11 which performs an overall control of the portable terminal 10; an external communications interface 13 which is a communications interface to communicate with an external apparatus via a cellular network; a display device 15 containing a liquid crystal display to display a variety of information for users; an audio output device 17 containing a speaker; a manipulation device containing a mechanical key switch and/or a touch panel; a GPS receiver 21 to detect a present position based on satellite electric waves (GPS signals) from GPS satellites; and a communications interface 23 having a connector CN1 for enabling a communications connection with the in-vehicle apparatus 50.

The control circuit 11 includes the following: a CPU 11a; a ROM 11b to store a program executed by the CPU 11a; a RAM 11c used as workspace at the time when the CPU 11a executes a program; and an NVRAM 11d (for example, flash memory) that is a nonvolatile memory in which data rewriting is possible electrically. The control circuit 11 performs an overall control of the portable terminal 10 by the CPU 11a executing a program stored in the ROM 11b, to achieve the various functions such as a telephone function, a music reproduction function, and a route guide function.

For example, the control circuit 11 has a music reproduction function to output from the audio output device 17 reproduced sounds of music data stored in the NVRAM 11d according to instructions inputted via the manipulation device 19. In addition, the control circuit 11 has a route guide function to acquire map data from an external server via the cellular network, retrieve a route to a destination designated via the manipulation device 19 based on the acquired map data and the present position detected by the GPS receiver 21, and guide the vehicle along the retrieved route with an audio guidance via the audio output device 17 and a route display via the display device 15.

In addition, in cases where the portable terminal 10 is connected with the in-vehicle apparatus 50 to enable communications, the control circuit 11 communicates with the in-vehicle apparatus 50 such that the reproduced sounds of music data may be outputted via the speaker 71 in the vehicle. In addition, the control circuit 11 acquires travel information of the vehicle such as a vehicle speed and a heading direction via the in-vehicle apparatus 50, and performs an operation of a song selection suitable for a driver's driving operation based on the acquired travel information. Furthermore, based on travel information, the control circuit 11 amends the present position detected based on the GPS signal, and processes an estimate of a present position based on the travel information if the GPS signal cannot be received.

In addition, under the connection with the in-vehicle apparatus 50 to enable the communications, the following are operated. The manipulation device 19 (in particular, touch panel) can accept instructions for not only the portable terminal 10 but also the in-vehicle apparatus 50 or apparatuses connected to or within the in-vehicle LAN. The instructions for the in-vehicle apparatus 50 or apparatuses within the in-vehicle LAN are inputted via the communications interface 23. Thereby, the instructions can be transmitted to the in-vehicle apparatus 50 or apparatuses within the in-vehicle LAN via the manipulation device 19. Moreover, the communications with the in-vehicle apparatus 50 enables a vehicle compartment environmental data, which is data indicating a vehicle compartment environment (i.e., a vehicle occupant compartment environment), to be stored in the NVRAM 11d that is explained later. The vehicle compartment environmental data can be used for specifying breakdown causes or anomaly occurrence causes of the portable terminal 10.

In contrast, the in-vehicle apparatus 50 includes the following: a control circuit 51 which performs an overall control of the in-vehicle apparatus 50; a communications interface 53 having a connector CN2 for enabling a communications connection with the portable terminal 10; a manipulation device 55 containing a mechanical key switch; an audio input device 57 containing a microphone; and a LAN interface 59 enabling communications with each node in the in-vehicle LAN.

The control circuit 51 includes the following: a CPU 51a; a ROM 51b to store a program executed by the CPU 51a; a RAM 51c used as workspace at the time when the CPU 51a executes a program; and an NVRAM 51d (for example, flash memory) that is a nonvolatile memory in which data rewriting is possible electrically. The control circuit 51 causes the CPU 51a to execute the various programs stored in the ROM 51b, achieving a variety of functions.

For example, the control circuit 51 executes a process to cause the in-vehicle apparatus 50 to function as a user interface to an information ECU (electronic control unit) connected to the in-vehicle LAN. That is, the instruction inputted via the manipulation device 55 is transmitted via the LAN interface 59 to the information ECU, which corresponds to the instruction and is connected to the in-vehicle LAN, enabling a user to operate the information ECU. Such an information ECU includes an audio ECU 70 having an audio function, for example. In addition, the control circuit 51 recognizes speeches inputted via the audio input device 57, and inputs an instruction corresponding to the inputted speeches to an electronic control device in the in-vehicle LAN corresponding to the instruction. Thus, the in-vehicle apparatus 50 functions as a user interface enabling a speech instruction or speech operation.

In addition, under the connection with the portable terminal 10 to enable the communications, the control circuit 51 receives not only the speech instruction to the in-vehicle apparatus 50 or apparatus in the in-vehicle LAN, but also the speech instruction to the portable terminal 10. The speech instruction to the portable terminal 10 is inputted via the communications interface 53 to the portable terminal 10. This achieves a speech instruction via the audio input device 57 to the portable terminal 10.

In addition, the control circuit 51 acquires measurement data indicating a measurement value of a physical quantity from a measurement instrument which measures a physical quantity indicating an environment in the vehicle occupant compartment via the ECU 80 connected to the in-vehicle LAN. Based on the measurement data, the vehicle compartment environmental data is stored in the NVRAM 51d. For instance, the temperature measurement data indicating a measurement value of the vehicle compartment temperature is acquired from a temperature sensor 81 connected to the ECU 80. The humidity measurement data indicating a measurement value of the vehicle compartment humidity is acquired from a humidity sensor 83 connected to the ECU 80. The vibration measurement data indicating a vibration level of the vehicle compartment is acquired from a vibration sensor 85 connected to the ECU 80.

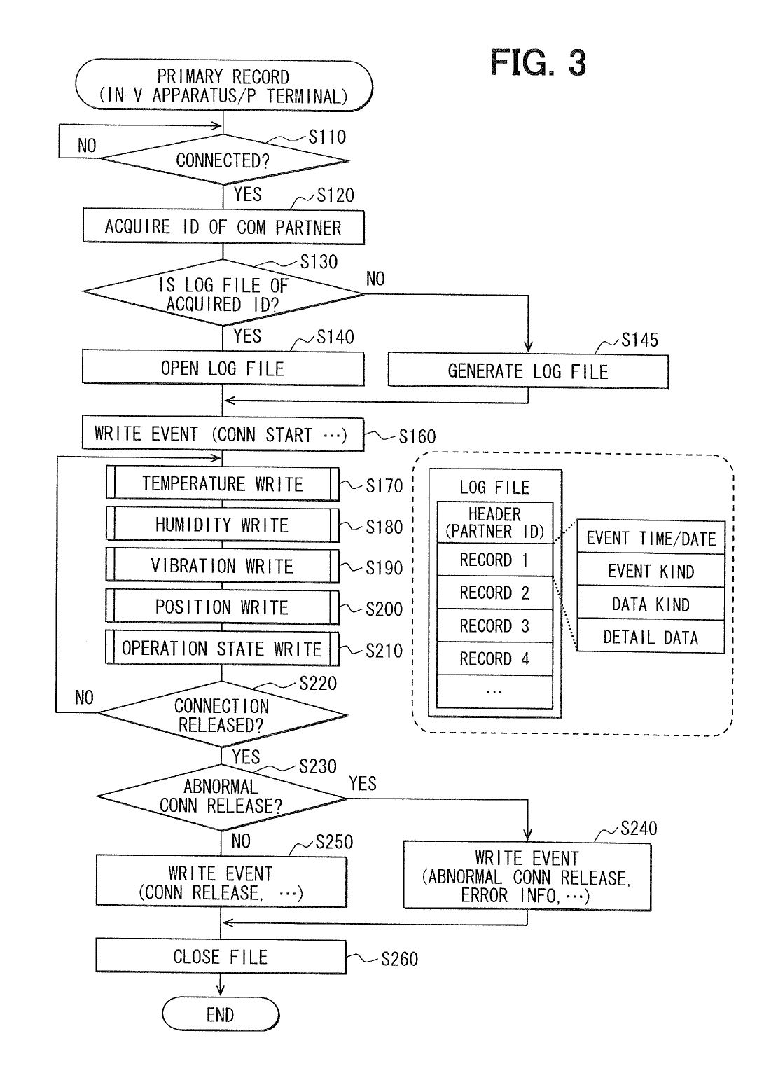

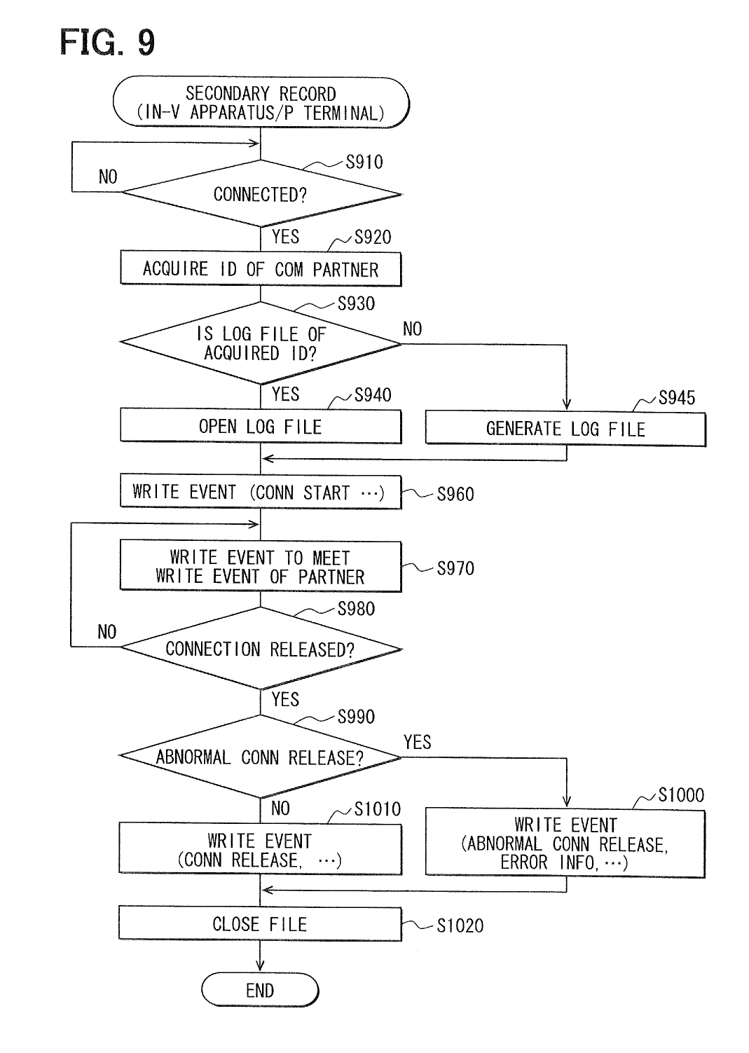

The following explains a process executed by the in-vehicle apparatus 50 and the portable terminal 10 so as to store the vehicle compartment environmental data. The following explains a primary recording process in FIG. 3 executed by the in-vehicle apparatus 50 and a secondary recording process in FIG. 9 executed by the portable terminal 10. In this regard, however, without need to be limited thereto, in the recording system 1 of the present embodiment, the primary recording process in FIG. 3 may be executed by the portable terminal 10 while the secondary recording process in FIG. 9 may be executed by the in-vehicle apparatus 50. A first case is where the primary recording process in FIG. 3 executed by the in-vehicle apparatus 50 and the secondary recording process in FIG. 9 executed by the portable terminal 10. A second case is where the primary recording process in FIG. 3 executed by the portable terminal 10 and the secondary recording process in FIG. 9 executed by the in-vehicle apparatus 50. The difference between the first case and the second case will be explained later. It is noted that, in the recording system 1 explained from now on, the in-vehicle apparatus 50 repeatedly executes the primary recording process regardless of the ignition switch being ON or OFF.

It is further noted that a flowchart or the processing of the flowchart in the present application includes sections (also referred to as steps), which are represented, for instance, as S110. Further, each section can be divided into several sub-sections while several sections can be combined into a single section. Furthermore, each of thus configured sections can be referred to as a means or unit and achieved not only as a software device but also as a hardware device.

As the control circuit 51 of the in-vehicle apparatus 50 starts the primary recording process illustrated in FIG. 3 with the CPU 51a executing the program, the control circuit 51 stands by until the connector CN2 of the communications interface 53 and the connector CN1 of the communications interface 23 are connected with each other so that the in-vehicle apparatus 50 and the portable terminal 10 are connected to enable the communications (S110). When the in-vehicle apparatus 50 and the portable terminal 10 are connected to enable the communications (S110: Yes), a connection partner's ID code (identification code) is acquired from a connection partner (S120).

That is, the control circuit 51 acquires an ID code of the portable terminal 10 serving as a connection partner via the communications interface 53. It is noted that a unique ID code is supposed to be assigned to each of the in-vehicle apparatus 50 and the portable terminal 10 in the present embodiment. In the recording system 1, the ID code may be stored in each of the in-vehicle apparatus 50 and the portable terminal 10 in a hardware manner or a software manner.

Then, the control circuit 51 determines whether a log file is already registered in the NVRAM 51d (S130). The log file is used under the connection with an apparatus corresponding to the acquired ID code. It is noted that the log file describes as header information the ID code of the apparatus corresponding to the log file. In the case where the log file describing as header information an ID code identical to the acquired ID code is already registered in the NVRAM 51d, the control circuit 51 makes an affirmative determination at S130. In other cases other than this case, the control circuit 51 makes a negative determination at S130.

When the affirmative determination is made (S130: Yes), the processing advances to S140, where the control circuit 51 reads out the corresponding log file into the RAM 51c and designates the read log file as an addition target of new records. In contrast, when the negative determination is made (S130: No), the processing advances to S145, where the control circuit 51 generates a new log file, where the ID code acquired at the present time is described as the header information, in the NVRAM 51d, and reads out the new log file into the RAM 51c, designating the read log file as an addition target of new records.

Then, the control circuit 51 generates a record, which describes a present time and date as an event time and date, and an event code indicating “connection start” as an event kind, and additionally registers the generated record in the log file designated as the addition target (S160). The record stored in the log file includes a field X1 where the event time and date is described; a field X2 where the event kind is described; a field X3 where a kind of detailed data is described; and a field X4 where the detailed data indicating detailed contents of the event is stored. The corresponding data may be stored in the field X3 or field X4 as needed.

Then, the control circuit 51 repeatedly executes a processing loop of S170 to S220 with time cycles until the connection between the in-vehicle apparatus 50 and the portable terminal 10 is canceled. The above time cycle may be selectively differentiated depending on either a traveling state where the vehicle is driven after the ignition switch is tuned into ON or a stopping state where the vehicle is stopped after the ignition switch is tuned into OFF. For instance, the execution time cycle in the stopping state may be set up to be longer than that in the traveling state.

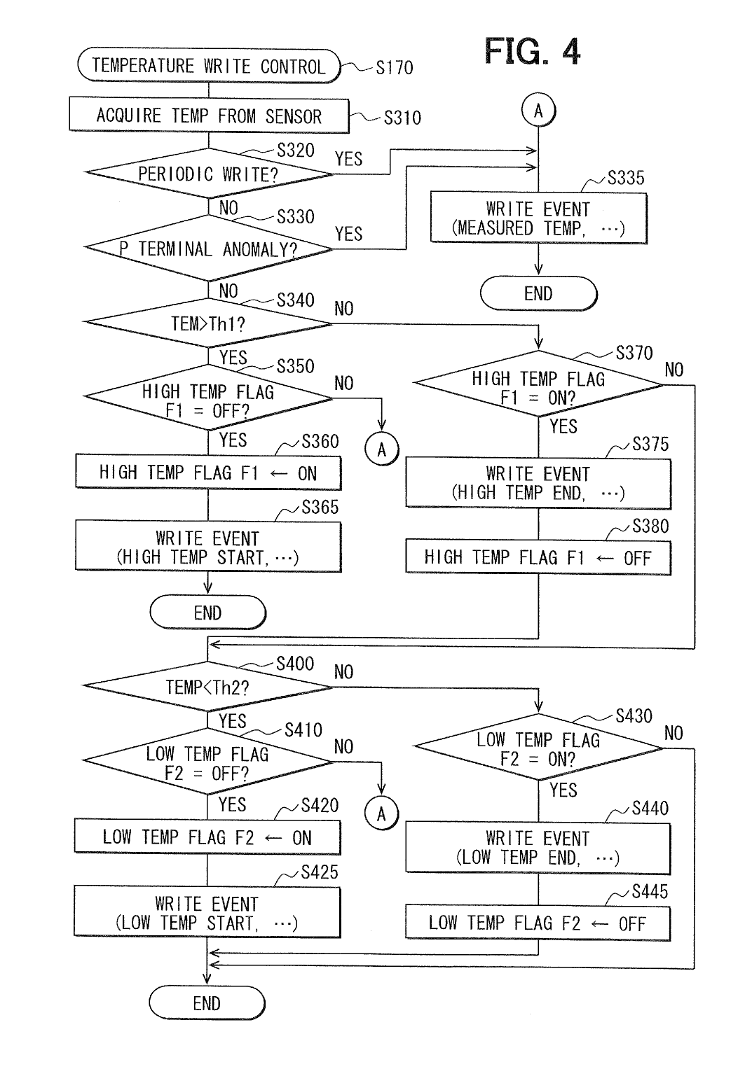

The processing loop will be explained. The temperature information write control process illustrated in FIG. 4 is executed at S170. In the temperature information write control process, the control circuit 51 acquires temperature measurement data indicating a measurement value of the vehicle compartment temperature from the temperature sensor 81 via the LAN interface 59 (S310). Then, it is determined whether the write mode is set to the periodic write mode (S320).

According to the present embodiment, the write mode to write vehicle compartment environmental data includes not only the periodic write mode, but also an anomaly-trigger write mode. The anomaly-trigger write mode is where vehicle compartment environment data is selectively written at the time when an anomaly arises in the vehicle compartment environment or the portable terminal 10. The in-vehicle apparatus 50 and the portable terminal 10 are designed such that a user's manipulation can switch the write mode between the periodic write mode and the anomaly-trigger write mode. That is, at S320, it is determined whether the write mode of the in-vehicle apparatus is set to the periodic write mode or the anomaly-trigger write mode.

When it is determined that the periodic write mode is set (S320: Yes), the processing advances to S335, where the control circuit 51 additionally registers a record in the log file. The record describes a present time and date as an event time and date, an event code which indicates “periodic write” as an event kind, a kind code which indicates “temperature” as a kind of detail data, and a measurement value (i.e., present temperature) of a vehicle compartment temperature indicated by the temperature measurement data as detail data. Then, the temperature information write control process is ended.

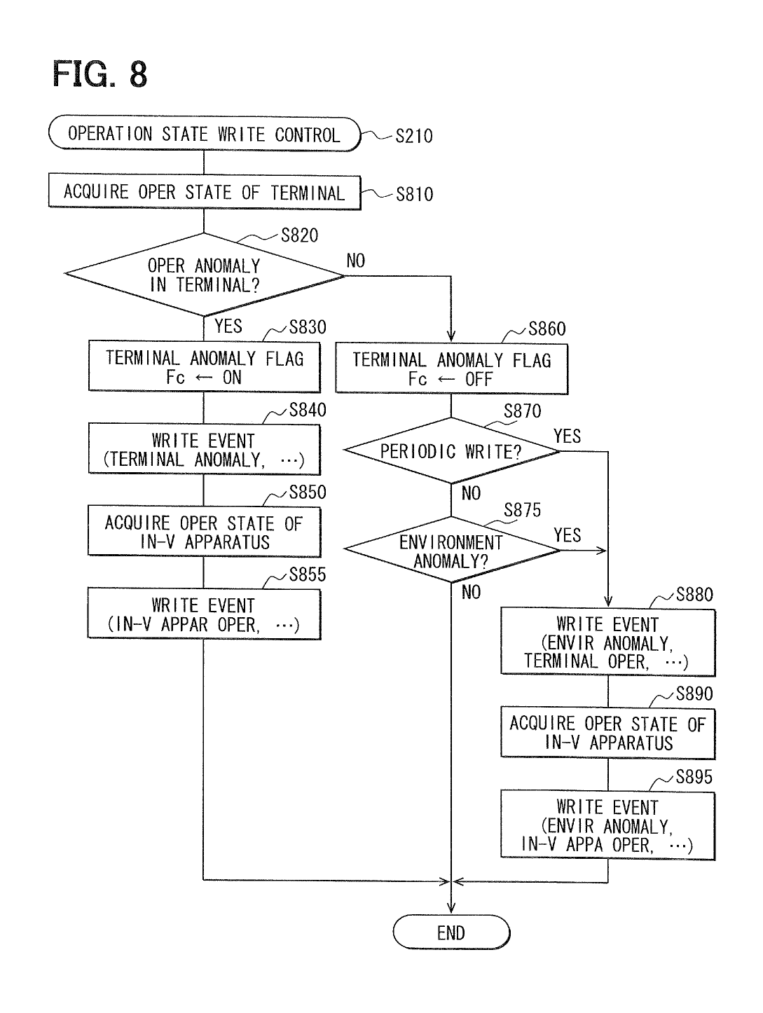

In contrast, when it is determined that the write mode is set to the anomaly-trigger write mode (S320: No), the control circuit 51 determines whether an operation anomaly arises in the portable terminal 10 (S330). The determination as to whether an operation anomaly arises in the portable terminal 10 is made based on a portable terminal anomaly arising flag Fc which is switched between ON and OFF by the operation state write control process (refer to FIG. 8). When the operation anomaly arises in the portable terminal 10, the portable terminal anomaly arising flag Fc is set to ON, while when the operation anomaly does not arise in the portable terminal 10, the portable terminal anomaly arising flag Fc is set to OFF. The initial value of the portable terminal anomaly arising flag Fc is set to “OFF.”

When it is determined that the operation anomaly occurs in the portable terminal 10 based on the portable terminal anomaly occurring flag Fc (S330: Yes), the processing advances to S335, where the control circuit 51 additionally registers a record in the log file. Such a record describes a present time and date as an event time and date, an event code which indicates “portable terminal anomaly” as an event kind, a kind code which indicates “temperature” as a kind of detail data, and a measurement value of a vehicle compartment temperature indicated by the temperature measurement data as detail data. Then, the temperature information write control process is ended.

In contrast, when the write mode is not the periodic write mode (S320: No), and the operation anomaly does not occur in the portable terminal 10 (S330: No), the processing advances to S340, where the control circuit 51 determines whether the measurement value of the vehicle compartment temperature indicated by the temperature measurement data exceeds a predetermined threshold value Th1. An object of the recording system 1 of the present embodiment is to store in a log file a record which specifies a cause of anomaly occurrence in the portable terminal 10. In the anomaly-trigger write mode, when the vehicle compartment temperature is within a temperature range not compliant with or meeting a specification of the portable terminal 10, the record that indicates the temperature anomaly is stored in the log file. In order to realize such an operation, the threshold value Th1 may be predetermined by a system designer of the recording system 1 based on an upper limit of the specification “the temperature range where the portable terminal 10 can be used.”For instance, the threshold value Th1 may be set to a temperature identical to the upper limit of “the temperature range where the portable terminal 10 can be used” which the manufacturer of the portable terminal 10 discloses as a specification. Alternatively, the threshold value Th1 may be set to a temperature lower than the above upper limit by a predetermined temperature.

Further, the threshold value Th1 may be stored previously in the ROM 11b in the portable terminal 10. When the determination at S340 is made, the in-vehicle apparatus 50 acquires the threshold value Th1 from the ROM 11b of the portable terminal 10, and compares it with the measurement data, detecting the abnormal vehicle compartment temperature not meeting the specification of the portable terminal 10.

When the measurement value exceeds the threshold value Th1 (S340: Yes), it is determined whether a high temperature flag F1 is set to OFF (S350). When the high temperature flag F1 is set to OFF (S350: Yes), the high temperature flag F1 is set to ON (S360). Then, the processing advances to S365, where the control circuit 51 additionally registers a record in the log file. Such a record describes a present time and date as an event time and date, and an event code which indicates “high temperature environment start” as an event kind. Then, the temperature information write control process is ended. It is noted that the high temperature flag F1 is a flag which indicates that the vehicle compartment environment is under unusually high temperature environment for the portable terminal 10.

In contrast, when the measurement value of the vehicle compartment temperature indicated by the temperature measurement data exceeds the threshold value Th1 (S340: Yes), and the high temperature flag F1 is set to ON (S350: No), it is indicated that the state where the vehicle compartment temperature exceeds the threshold value Th1 continues. The processing thus advances to S335, where the control circuit 51 additionally registers a record in the log file. Such a record describes a present time and date as an event time and date, an event code which indicates “temperature anomaly” as an event kind, a kind code which indicates “temperature” as a kind of detail data, and a measurement value of a vehicle compartment temperature indicated by the temperature measurement data as detail data. Thereby, even in the anomaly-trigger write mode, under the high temperature environment where the vehicle compartment temperature exceeds the threshold value Th1, the record that describes the present vehicle compartment temperature is written into the log file periodically. Then, the temperature information write control process is ended.

In contrast, the measurement data of the vehicle compartment temperature indicated by the temperature measurement data is equal to or less than the threshold value Th1 (S340: No), the control circuit 51 determines whether the high temperature flag F1 is set to ON. It is thereby determined whether the high temperature environment of the vehicle compartment is finished (S370). When the high temperature flag F1 is set to ON (S370: Yes), the processing advances to S375, where the control circuit 51 additionally registers a record in the log file. Such a record describes a present time and date as an event time and date, an event code which indicates “high temperature environment end” as an event kind, a kind code which indicates “high temperature environment detail” as a kind of detail data, and a duration T1 of high temperature environment (also referred to as high temperature duration T1) as detailed data. Then, the high temperature flag F1 is set to OFF (S380); then, the processing advances to S400.

It is noted that the high temperature duration T1 corresponds to a duration from the start time to the end time of the high temperature (i.e., a duration from when the high temperature flag F1 is set to ON to when the high temperature flag F1 is set to OFF) while corresponding to a difference between the event time and date of the record registered at the start time of the high temperature environment and the present time and date being the end time of the high temperature environment.

Moreover, when the measurement value of the vehicle compartment temperature indicated by the temperature measurement data is equal to or less than the threshold value Th1 (S340: No), and it is determined that the high temperature flag F1 is set to OFF (S370: No), the vehicle compartment is neither under the high temperature environment nor just after the end of the high temperature environment. The processing thus advances to S400, without registering any record.

At S400, the control circuit 51 determines whether the measurement value of the vehicle compartment temperature indicated by the temperature measurement data is less than a predetermined threshold value Th2. It is thereby determined whether the vehicle compartment is under low temperature environment. It is noted that, similar to the threshold value Th1, the threshold value Th2 may be predetermined based on the specification “the temperature range where the portable terminal 10 can be used.” For instance, the threshold value Th2 is predetermined, on the basis of a lower limit of the specification “temperature range where the portable terminal 10 can be used,” to be a temperature value identical to or higher by some degrees than the lower limit.

Further, the threshold value Th2 may be also stored previously in the ROM 11b in the portable terminal 10. When the determination at S400 is made, the in-vehicle apparatus 50 acquires the threshold value Th2 from the ROM 11b of the portable terminal 10. At 5400, the threshold value Th2 is compared with the measurement value of the vehicle compartment temperature to thereby determine whether the vehicle compartment is under the low temperature unusual for the portable terminal 10.

In contrast, when the measurement value of the vehicle compartment temperature indicated by the temperature measurement data is less than the threshold value Th2 (S400: Yes), it is determined whether the low temperature flag F2 is set to OFF (S410). When the low temperature flag F2 is set to OFF (S410: Yes), the low temperature flag F2 is set to ON (S420). The processing then advances to S425, where the control circuit 51 additionally registers a record in the log file. Such a record describes a present time and date as an event time and date, and an event code which indicates “low temperature environment start” as an event kind. Then, the temperature information write control process is ended. It is noted that the low temperature flag F2 is a flag which indicates that the vehicle compartment environment is under unusually low temperature environment for the portable terminal 10.

In contrast, when the measurement value of the vehicle compartment temperature indicated by the temperature measurement data is less than the threshold value Th2 (S400: Yes), and it is determined that the low temperature flag F2 is set to ON (S410: Yes), it is indicated that the state where the vehicle compartment temperature is less than the threshold value Th2 continues. The processing thus advances to S335, where the control circuit 51 additionally registers a record in the log file. Such a record describes a present time and date as an event time and date, an event code which indicates “temperature anomaly” as an event kind, a kind code which indicates “temperature” as a kind of detail data, a measurement value of the vehicle compartment temperature indicated by the temperature measurement data as detail data. Then, the temperature information write control process is ended. Thereby, even in the anomaly-trigger write mode, under the low temperature environment where the vehicle compartment temperature is less than the threshold value Th2, the record that describes the present vehicle compartment temperature is written into the log file.

In contrast, when the measurement value of the vehicle compartment temperature indicated by the temperature measurement data is equal to or greater than the threshold value Th2 (S400: No), and it is determined that the low temperature flag F2 is set to ON (S430: Yes), The processing then advances to S440, where the control circuit 51 additionally registers a record in the log file. Such a record describes a present time and date as an event time and date, an event code which indicates “low temperature environment end” as an event kind, a kind code which indicates “low temperature environment detail” as a kind of detail data, and a duration (T2) of low temperature environment (also referred to as a low temperature duration T2) as detailed data. Then, the low temperature flag F2 is set to OFF (S445). Then, the temperature information write control process is ended. It is noted that the low temperature duration T2 corresponds to a duration from the start time to the end time of the low temperature (i.e., a duration from when the low temperature flag F2 is set to ON to when the low temperature flag F2 is set to OFF) while corresponding to a difference between the event time and date of the record registered at the start time of the low temperature environment and the present time and date being the end time of the low temperature environment.

In contrast, when the measurement value of the vehicle compartment temperature indicated by the temperature measurement data is equal to or greater than the threshold value Th2 (S400: No), and it is determined that the low temperature flag F2 is set to OFF (S410: No), the vehicle compartment temperature is in a temperature range suitable with respect to a specification of the portable terminal 10. Without registering any record in the anomaly-trigger write mode, the temperature information write control process is then ended.

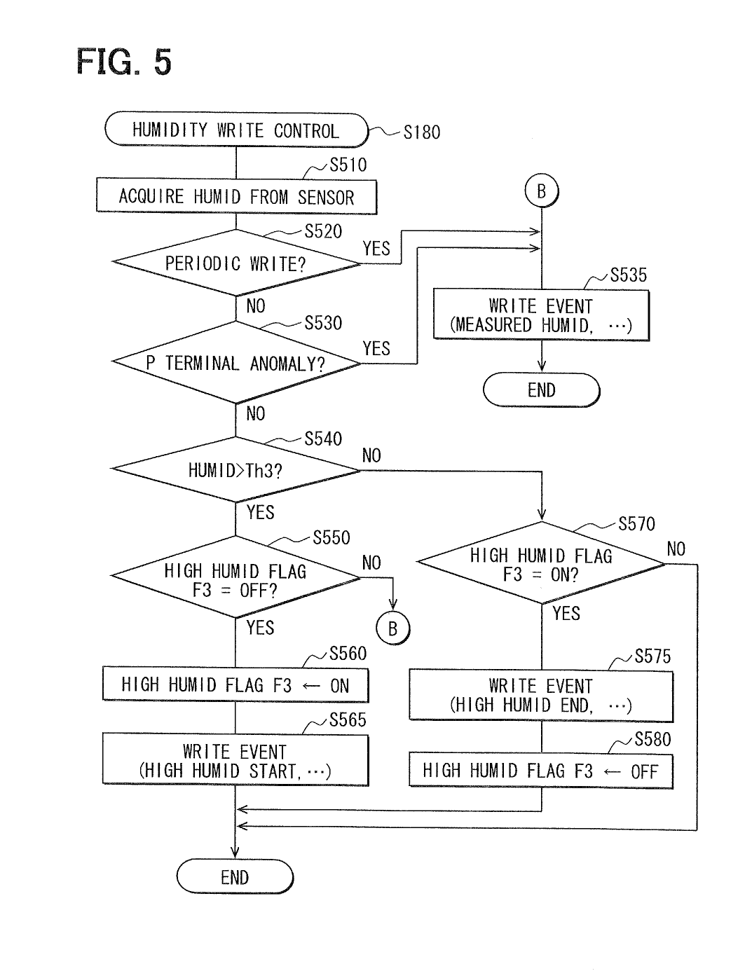

After executing the temperature information write control process, the processing of the control circuit 51 advances to S180, where a humidity information write control process illustrated in FIG. 5 is executed. It is noted that similar to the temperature information write control process, the humidity information write control process records information on vehicle compartment humidity in the log file.

As the humidity information write control process is started, the control circuit 51 acquires the humidity measurement data indicating a measurement value of the vehicle compartment humidity from the humidity sensor 83 (S510). When the write mode is the periodic write mode, or when an operation anomaly occurs in the portable terminal (S520: Yes, or S530: Yes), the processing then advances to S535, where the control circuit 51 additionally registers a record in the log file. Such a record describes a present time and date as an event time and date, an event code indicating “periodic write” or “portable terminal anomaly” as an event kind, a kind code which indicates “humidity” as a kind of detail data, a measurement value (present humidity) of a vehicle compartment humidity indicated by the humidity measurement data as detail data. Then, the humidity information write control process is ended.

In contrast, when it is determined that the write mode is set to the anomaly-trigger write mode (S520: No), and the operation anomaly of the portable terminal 10 does not occur (S530: No), it is determined whether the measurement value indicated by the humidity measurement data exceeds a predetermined threshold value Th3 based on the specification of the portable terminal 10 (S540). It is noted that the threshold value Th3 is predetermined on the basis of the upper limit of the specification “the humidity range where the portable terminal 10 can be used.”

Further, the threshold value Th3 may be stored previously in the ROM 11b in the portable terminal 10. When the determination at S540 is made, the in-vehicle apparatus 50 acquires the threshold value Th3 from the ROM 11b of the portable terminal 10, and compares it with the measurement data to detect the abnormal vehicle compartment humidity not meeting the specification of the portable terminal 10. When the measurement value of the humidity exceeds the threshold value Th3 (S540: Yes) and the high humidity flag F3 is set to OFF (S550: Yes), the high humidity flag F3 is set to ON (S560). The processing then advances to S565, where the control circuit 51 additionally registers a record in the log file. Such a record describes a present time and date as an event time and date, and an event code which indicates “high humidity environment start” as an event kind. Then, the humidity information write control process is ended.

In contrast, when (i) the measurement value of the vehicle compartment humidity indicated by the humidity measurement data exceeds the threshold value Th3 (S540: Yes), and (ii) the high humidity flag F1 is set to ON (S550: No), the processing advances to S535, where the control circuit 51 additionally registers a record in the log file. Such a record is identical to the record in the periodic write other than describing an event code indicating “the humidity anomaly” as an event kind. Thereby, even in the anomaly-trigger write mode, under the high humidity environment where the vehicle compartment humidity exceeds the threshold value Th3, the record that describes the present vehicle compartment humidity is written into the log file. Then, the humidity information write control process is ended.

In contrast, when the measurement value indicated by the humidity measurement data is less than threshold value Th3 (S540: No) and the high humidity flag F3 is set to ON (S570: Yes), the processing advances to S575, where the control circuit 51 additionally registers a record in the log file. Such a record describes a present time and date as an event time and date, an event code which indicates “high humidity environment end” as an event kind, a kind code which indicates “high humidity environment detail” as a kind of detail data, and a high humidity duration T3 from the start time to the end time of the high humidity environment as a detail data. Then, the high humidity flag F3 is set to OFF (S580). Then, the humidity information write control process is ended.

In addition, when the measurement value indicated by the humidity measurement data is equal to or less than the threshold value Th3 (S540: No) and the high humidity flag F3 is set to OFF, the vehicle compartment is neither under the high humidity environment nor just after the end of the high humidity environment. Without registering any record, the humidity information write control process is thereby ended.

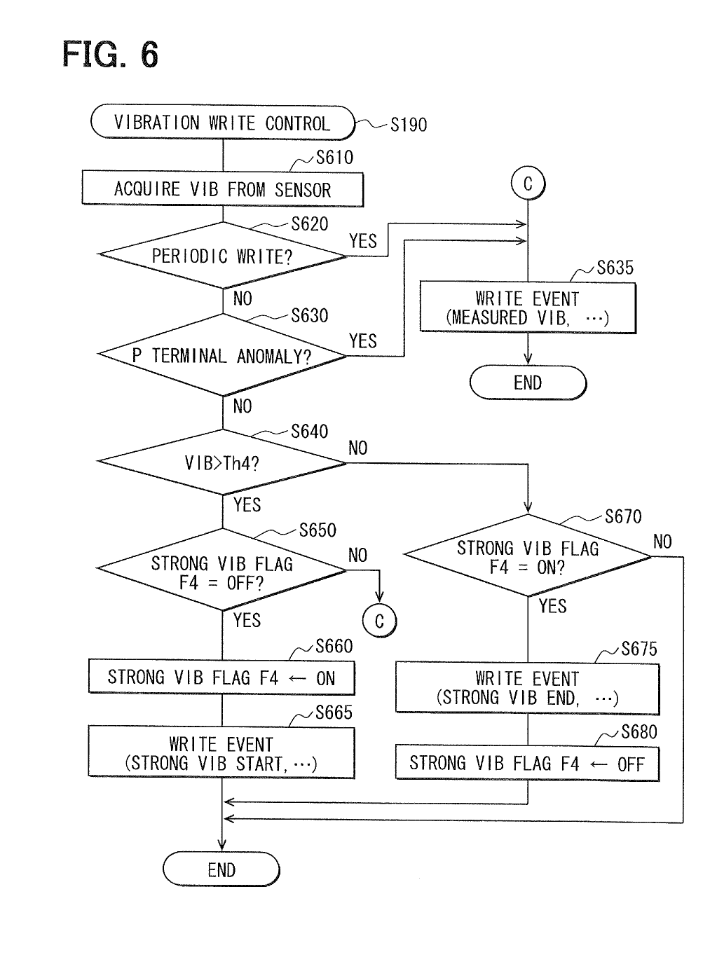

After the humidity information write control process is ended, the processing of the control circuit 51 advances to S190, where a vibration information write control process illustrated in FIG. 6 is executed. It is noted that similar to the temperature information write control process or the humidity information write control process, the vibration information write control process records information on vehicle compartment vibration in the log file.

As the vibration information write control process is started, the control circuit 51 acquires the vibration measurement data indicating a measurement value of the vehicle compartment vibration level from the vibration sensor 85 (S610). When the write mode is the periodic write mode, or when the operation anomaly of the portable terminal 10 occurs (S620: Yes or S630: Yes), the processing then advances to S635, where the control circuit 51 additionally registers a record in the log file. Such a record describes a present time and date as an event time and date, an event code indicating “periodic write” or “portable terminal anomaly” as an event kind, a kind code which indicates “vibration level” as a kind of detail data, and a measurement value (present vibration level) of a vehicle compartment vibration level indicated by the vibration measurement data as detail data. Then, the vibration information write control process is ended.

In contrast, when it is determined that the write mode is set to the anomaly-trigger write mode (S620: No), and the operation anomaly of the portable terminal 10 does not occur (S630: No), it is determined whether the measurement value indicated by the vibration measurement data exceeds a predetermined threshold value Th4 based on the specification of the portable terminal 10 (S640, S650). It is noted that the threshold value Th4 is predetermined on the basis of the upper limit of the specification “the vibration level range where the portable terminal 10 can be used.”

Further, the threshold value Th4 may be stored previously in the ROM 11b in the portable terminal 10. When the determination at S640 is made, the in-vehicle apparatus 50 acquires the threshold value Th4 from the ROM 11b of the portable terminal 10, and compares it with the measurement data to detect the abnormal vehicle compartment temperature not suiting to the specification of the portable terminal 10.

When the measurement value of the vibration level exceeds the threshold value Th4 (S640: Yes), and the strong vibration flag F4 is set to OFF (S650: Yes), the strong vibration flag F4 is set to ON (S660). The processing then advances to S665, where the control circuit 51 additionally registers a record in the log file. Such a record describes a present time and date as an event time and date, and an event code which indicates “strong vibration environment start” as an event kind. Then, the vibration information write control process is ended.

In addition, when the measurement value indicated by the vibration measurement data exceeds the threshold value Th4 (S640: Yes) and the strong vibration flag F4 is set to ON (S650: No), the processing advances to S635, where the control circuit 51 additionally registers a record in the log file. Such a record is identical to the record in the periodic write other than describing an event code indicating “vibration anomaly” as an event kind. Thereby, even in the anomaly-trigger write mode, under the strong vibration environment where the vehicle compartment vibration level exceeds the threshold value Th4, the record that describes the present vehicle compartment vibration level is written into the log file. Then, the vibration information write control process is ended.

In contrast, when the measurement value indicated by the vibration measurement data is equal to or less than the threshold value Th4 (S640: No) and the strong vibration flag F4 is set to ON (S670: Yes), the processing then advances to S675, where the control circuit 51 additionally registers a record in the log file. Such a record describes a present time and date as an event time and date, an event code indicating “strong vibration environment end” as an event kind, a kind code which indicates “strong vibration environment detail” as a kind of detail data, and a strong vibration duration T4 from the start time to the end time of the strong vibration environment as a detail data. Then, the strong vibration flag F4 is set to OFF (S680). Then, the vibration information write control process is ended.

In addition, when the measurement value indicated by the vibration measurement data is equal to or less than the threshold value Th4 (S640: No) and the strong vibration flag F4 is set to OFF (S670: No), the vehicle compartment is neither under the strong vibration environment nor just after the end of the strong vibration environment. Without registering any record, the vibration information write control process is thereby ended.

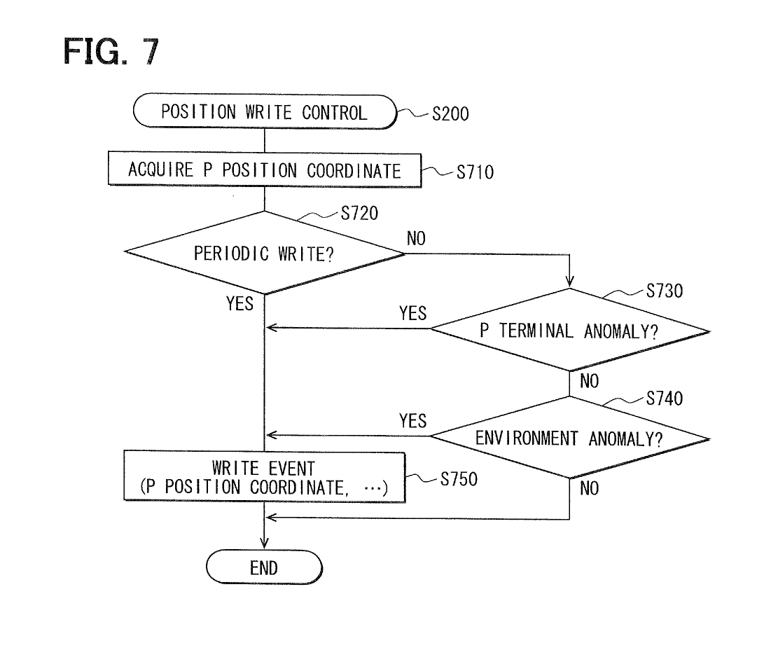

After the vibration information write control process is ended, the control circuit 51 executes the position information write control process illustrated in FIG. 7 (S200). As the position information write control process is started, the control circuit 51 acquires coordinate data of the present position from the portable terminal 10 having the GPS receiver 21 via the communications interface 53 (S710). Then, it is determined whether the write mode is set to the periodic write mode (S720).

When the write mode is set to the periodic write mode (S720: Yes), the processing advances to S750, where the control circuit 51 additionally registers a record in the log file. Such a record describes a present time and date as an event time and date, an event code indicating “periodic write” as an event kind, a kind code which indicates “position coordinate” as a kind of detail data, and the present position coordinate indicated by the acquired coordinate data as detailed data. Then, the position information write control process is ended.

In contrast, when the write mode is not the periodic write mode but the anomaly-trigger write mode (S720), the following takes place. Only when the operation anomaly occurs in the portable terminal 10 or the vehicle compartment environment (S730: Yes or S740: Yes), the processing advances to S750, where the control circuit 51 additionally registers a record in the log file. Such a record is identical to the record in the periodic write mode other than describing an event code indicating “the portable terminal anomaly” or “environment anomaly” as an event kind.

In detail, it is determined based on the portable terminal anomaly occurrence flag Fc whether an operation anomaly occurs in the portable terminal 10 (S730). When the operation anomaly occurs in the portable terminal 10, the processing advances to S750, where the control circuit 51 registers a record describing as an event kind “portable terminal anomaly” in the log file (S750). In contrast, when the operation anomaly does not occur in the portable terminal 10 (S730: No), it is determined based on flags F1, F2, F3, and F4 whether an anomaly occurs in the vehicle compartment environment (S740). When at least one of flags F1, F2, F3, and F4 is set to ON, it is determined that an anomaly occurs in the vehicle compartment environment (S740: Yes), registering in the log file a record describing as an event kind “environment anomaly” (S750). In addition, when the flag Fc is set to OFF and all the flags F1, F2, F3, and F4 are set to OFF (S730: No, S740: No), any anomaly does not occur in either of the portable terminal 10 and the vehicle compartment environment. In the anomaly-trigger write mode, any record is thus not registered. The position information write control process is then ended.

After the position information write control process is ended, the processing of the control circuit 51 advances to S210, where an operation state write control process illustrated in FIG. 8 is executed. As the operation state write control process is started, the control circuit 51 acquires information indicating an operation state of the portable terminal 10 from the portable terminal 10 via the communications interface 53 (S810). The control circuit 51 determines whether an operation anomaly occurs in the portable terminal 10 based on the acquired information (S820).

In detail, the information indicating the operation state of the portable terminal 10 acquired at S810 includes the following: a use amount of the CPU and use amount of the memory in the portable terminal 10; a list of processes executed by the CPU 11a; a use amount of the CPU and a use amount of the memory in each process; an error code of a process which outputs an error code; and information indicating a virus detecting state of a security software program which checks a computer virus.

At S820, the control circuit determines that there is a process that outputs an error code or that the security software program detects a virus based on the acquired information indicating the operation state of the portable terminal 10, thereby determining that the operation anomaly occurs in the portable terminal 10. In addition, when without receiving any response from the portable terminal 10 the control circuit 51 cannot acquire information indicating the operation state of the portable terminal 10 even though the portable terminal 10 is connected to the connector CN2, (i.e., when the portable terminal 10 freezes), it is determined that the operation anomaly occurs in the portable terminal 10. In contrast, when the portable terminal does not freeze, any virus is not detected, and any executed process does not output an error code, it is determined that the operation anomaly does not occur in the portable terminal 10.

When it is determined that the operation anomaly occurs (S820: Yes), the portable terminal anomaly occurrence flag Fc indicating the presence or absence of the operation anomaly in the portable terminal 10 is set to ON (S830). The processing then advances to S840, where the control circuit 51 additionally registers a record in the log file. Such a record describes a present time and date as an event time and date, an event code indicating “portable terminal anomaly” as an event kind, a kind code which indicates “portable terminal anomaly detail” as a kind of detail data, and the operation anomaly detail of the portable terminal as detail data.

In detail, the detail data described as the information indicating the anomaly kind resulting in the affirmative determination at S820 are as follows: the information indicating a freeze occurrence, an error code kind, or a detected virus kind; and the information indicating the present operation state based on the information indicating the operation state acquired at S810, such as a use amount of the CPU and a use amount of the memory in the portable terminal 10, a list of processes executed by the CPU 11a, and a use amount of the CPU and a use amount of the memory in each process.

Then, the information indicating the operation state of the in-vehicle apparatus 50 is acquired (S850). The information indicating the operation state includes the following: a use amount of the CPU and a use amount of the memory in the in-vehicle apparatus 50; a list of processes executed by the CPU 51a; and a use amount of the CPU and a use amount of the memory in each process. Additional registration into the log file is made with respect to the record describing the operation state of the in-vehicle apparatus 50 (S855). That is, the control circuit 51 additionally registers a record in the log file. Such a record describes a present time and date as an event time and date, an event code indicating “in-vehicle apparatus anomaly” as an event kind, a kind code which indicates “in-vehicle apparatus anomaly detail” as a kind of detail data, and the operation anomaly detail of the in-vehicle apparatus 50 that was acquired at S850, as detailed data. Then, the operation state write control process is ended. Moreover, at S855, a list of the data under communications between the portable terminal 10 and the in-vehicle apparatus 50 may be described in the record.

In contrast, when it is determined that the operation anomaly of the portable terminal 10 does not occur (S820: No), the control circuit 51 sets the portable terminal anomaly occurrence flag Fc indicating presence or absence of an anomaly in the portable terminal 10, to OFF (S860). Then, it is determined whether the write mode is set to the periodic write mode (S870). When the write mode is set to the periodic write mode (S870: Yes), the control circuit 51 additionally registers a record in the log file at S880. Such a record describes a present time and date as an event time and date, an event code indicating “periodic write” as an event kind, a kind code which indicates “portable terminal operation detail” as a kind of detail data, and the operation state of the portable terminal as detailed data.

In detail, at S880, based on the information indicating the operation state acquired at S810, an additional registration into the log file is made with respect to a record describing as detail data the information indicating a use amount of the CPU and a use amount of the memory in the portable terminal 10; a list of processes executed by the CPU 11a; and a use amount of the CPU and a use amount of the memory in each process.

Furthermore, similar to the processing at S850, the control circuit 51 acquires the information indicating the operation state of the in-vehicle apparatus 50 (S890). Additional registration into the log file is made with respect to the record describing the operation state of the in-vehicle apparatus 50 (S895), similar to the processing at S855. However, at S895 subsequent to the affirmative determination at S870, the additional registration into the log file is made with respect to the record which described the event code indicating “periodic write” as an event kind. Then, the operation state write control process is ended. Further, even in cases where the operation anomaly of the portable terminal 10 does not occur (S820: No), when the write mode is set to the anomaly-trigger write mode (S870: No), it is determined whether the anomaly occurs in the vehicle compartment environment (S875), similar to the processing at S740. When it is determined that the operation anomaly occurs in the vehicle compartment environment (S875: Yes), the processing at S880, S890, S895 is executed like in the periodic write mode. It is noted that at S880 and S895 subsequent to the affirmative determination at S875, the additional registration into the log file is made with respect to a record describing as an event kind an event code indicating “environment anomaly”. Then, the operation state write control process is ended.

In addition, when (i) the operation anomaly does not occur in the portable terminal 10 (S820: No), (ii) the write mode is set to the anomaly-trigger write mode (S870: No), and (iii) the operation anomaly does not occur in the vehicle compartment environment (S875: No), the operation state write control process is ended without registering any record.

After completing the operation state write control process, the control circuit 51 determines whether the connection between the in-vehicle apparatus 50 and the portable terminal 10 is released (FIG. 3: S220). When the connection is not released (S220: No), the processing advances to S170, where the above-mentioned processing loop is repeatedly executed until the connection is released.

In addition, when the connection is released (S220: Yes), it is determined whether the connection release is an abnormal connection release indicating that the portable terminal 10 is detached from the connector CN2 without undergoing an appropriate procedure (S230). When it is the abnormal connection release (S230: Yes), the following record is generated and additionally registered in the log file (S240). The record describes a present time and date as an event time and date, an event code which indicates “abnormal connection release” as an event kind, a kind code which indicates “connection information detail” as a data kind, and error information indicating the kind of anomaly regarding the connection release and the connection duration from the connection start time to the present time, as detail data. Then, a write operation in which the edited log file is written into the NVRAM 51d (i.e., an update operation in which the log file registered in the NVRAM 51d is updated), and the log file is closed (S260). The primary recording process is then ended.

In contrast, when the connection release is a normal connection release which undergoes an appropriate procedure (S230: No), the control circuit 51 additionally generate to register a record in the log file at S250. Such a record describes a present time and date as an event time and date, an event code indicating “connection release” as an event kind, a kind code which indicates “connection information detail” as a data kind, and the connection duration from the connection start time to the present time as detailed data. Then, the primary recording process is ended after executing the processing at S260 mentioned above.

The following explains the secondary recording process illustrated in FIG. 9 and executed by the portable terminal 10. The control circuit 11 of the portable terminal 10 repeatedly executes the secondary recording process illustrated in FIG. 9 while the power source of the portable terminal 10 is set to ON.

As the control circuit 11 of the portable terminal 10 starts the secondary recording process with the CPU 11a executing the program, the control circuit 11 stands by until the connector CN1 of the communications interface 23 and the connector CN2 of the communications interface 53 are connected with each other so that the in-vehicle apparatus 50 and the portable terminal 10 are connected to enable the communications (S910). When the portable terminal 10 and the in-vehicle apparatus 50 are connected to enable the communications (S910: Yes), the control circuit 11 acquires the ID code of the in-vehicle apparatus 50 serving as a connection partner (S920).

Furthermore, with the procedure similar to that at S130, it is determined whether the log file corresponding to the acquired ID code is already registered in the NVRAM 11d (S930). When the log file is already registered (S930: Yes), the processing advances to S940, where the corresponding log file is read into the RAM 11c, and designates the read log file as an addition target of new records. In contrast, the negative determination is made (S930: No), the processing advances to S945, where a new log file is generated in the NVRAM 11d. The new log file describes as header information the ID code acquired at this time. Further, the corresponding log file is read into the RAM 11c, and designates the read log file as an addition target of new records.

Then, the control circuit 11 generates a record, which describes a present time and date as an event time and date, and an event code indicating “connection start” as an event kind, and additionally registers the generated record in the log file designated as the addition target (S960). The data configuration of the record registered in the log file is identical to that mentioned above.

After completing the processing at S960, the control circuit 11 carries out additional registration into the log file of the portable terminal 10 in synchronization with the additional registration in the log file of the in-vehicle apparatus 50 until the connection with the in-vehicle apparatus 50 is released (S970). In the additional registration in the portable terminal, the record having the data contents identical to those of the record registered in the log file of the in-vehicle apparatus 50. Thus, in the present embodiment, the in-vehicle apparatus 50 and the portable terminal 10 store in the log files the records of which the data contents are identical to each other. Further, the data contents of the record registered in the log file in the in-vehicle apparatus 50 can be acquired from the in-vehicle apparatus 50 via the communications interface 23.

When the connection with the in-vehicle apparatus 50 is released (S980: Yes), it is determined whether the connection release is an abnormal connection release indicating that the in-vehicle apparatus 50 is detached from the connector CN1 without undergoing an appropriate procedure (S990). When it is the abnormal connection release (S990: Yes), similar to the processing at S240, the control circuit 11 additionally generates a record and registers the generated record in the log file at S1000. Such a record describes a present time and date as an event time and date, an event code indicating “abnormal connection release” as an event kind, a kind code which indicates “connection information detail” as a data kind, and the error information and the connection duration from the connection start time to the present time as detailed data. Then, a write operation in which the edited log file is written into the NVRAM 11d (i.e., an update operation in which the log file registered in the NVRAM 11d is updated), and the log file is closed (S1020). The secondary recording process is then ended.

In contrast, when the connection release is a normal connection release which undergoes an appropriate procedure (S990: No), the additional registration into the log file is made with respect to the record having the data contents identical to those of the record registered at S250 (S1010). After completing the processing at S1020, the secondary recording process is ended.

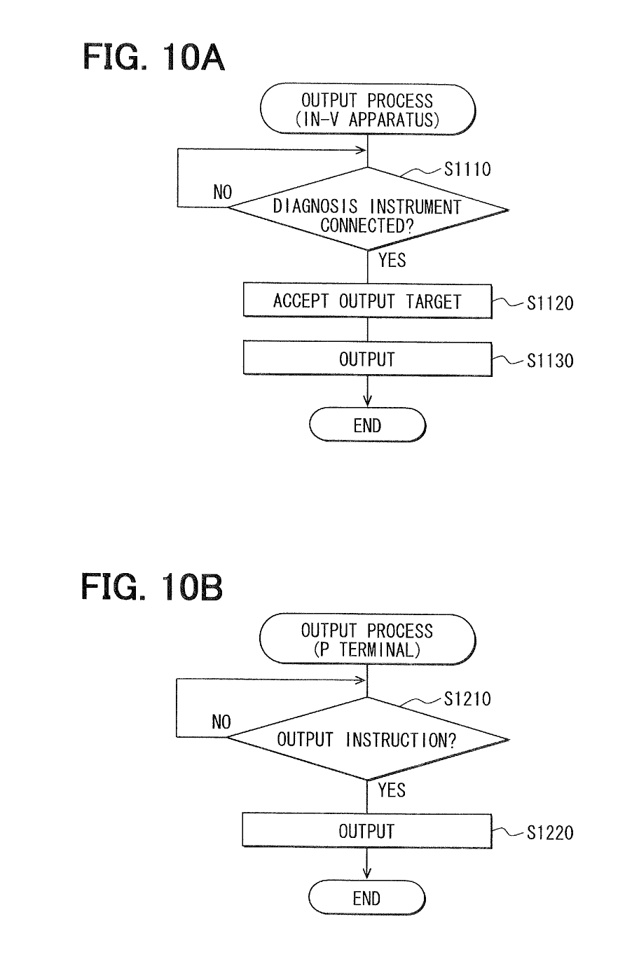

In the above, the primary recording process and secondary recording process were explained. As a result, the log files are stored in the NVRAM 11d and the NVRAM 51d; these log files are outputted as needed from the in-vehicle apparatus 50 and the portable terminal 10, respectively. For example, as illustrated in FIG. 10A, the in-vehicle apparatus 50 performs as follows. When a vehicle diagnostic apparatus 90 is connected from an outside to the in-vehicle LAN via the connector CN3 (see FIG. 2) (S1110: Yes), the in-vehicle apparatus 50 communicates with the vehicle diagnostic apparatus 90 via the LAN interface 59, and receives an output target designation operation from the vehicle diagnostic apparatus 90 (S1120). The data appointed from the vehicle diagnostic apparatus 90 is read from the log file, and is outputted to the vehicle diagnostic apparatus 90 (S1130). For example, a record of the appointed time and date in the log file having the appointed ID code is read from the log file, and is outputted.

In contrast, as illustrated in FIG. 10B, the portable terminal 10 operates as follows. When an output instruction of the log file is inputted via the manipulation device 19 (S1210), the data contents of the log file having the ID code of which output is requested is displayed on a screen in the display device 15 (S1220).

In the above detailed explanation, the primary recording process is executed by the in-vehicle apparatus 50, whereas the secondary recording process is executed by the portable terminal 10. In this regard, however, as explained in the above, the primary recording process may be executed by the portable terminal 10, whereas the secondary recording process may be executed by the in-vehicle apparatus 50.

The following explains the case where the portable terminal 10 executes the primary recording process. The ID code is acquired from the in-vehicle apparatus 50 (S120). The NVRAM 11d is searched for the log file corresponding to the acquired ID code. The corresponding log file is deployed in the RAM 11c, and a record is registered in the deployed log file at the processing subsequent to S160. In addition, it is determined whether the in-vehicle apparatus 50 is removed from the connector CN1 (S220). When removed, it is determined whether it is an abnormal connection release (S230). The record corresponding to normal/abnormal connection release is registered in the log file (S250, S240). The log file after editing is written in the NVRAM 11d (S260) to update the log file in the NVRAM 11d. In addition, at S170, S180, and S190, each of the temperature measurement data, the humidity measurement data, and the vibration measurement data is acquired from each sensor in the in-vehicle apparatus 50 via the communications interface 23. Similarly, in the operation state write control process, the information indicating the operation state of the in-vehicle apparatus 50 is acquired from the in-vehicle apparatus 50 via the communications interface 23. Even when the portable terminal 10 executes the primary recording process, at S820 of the operation state write control process, the presence or absence of the operation anomaly of the portable terminal 10 is determined. Processing at S330, S530, S630, and S730 is also the same.

Further, as explained above, the ROM 11b in the portable terminal 10 may previously store the threshold values Th1, Th2, Th3, Th4; thus, when comparing with the measurement data acquired from the in-vehicle apparatus 50, those threshold values Th1 to Th4 are read out from the ROM 11b, respectively.

The following explains the case where the in-vehicle apparatus 50 executes the secondary recording process. The ID code is acquired from the portable terminal 10 (S910). The NVRAM 51d is searched for the log file corresponding to the acquired ID code. The corresponding log file is deployed in the RAM 51c. The record having data contents identical to those of the record of the portable terminal 10 is registered in this log file (S960, S970). In addition, it is determined whether the portable terminal 10 is removed from the connector CN2 (S980). When removed, it is determined whether it is an abnormal connection release (S990). The record corresponding to normal/abnormal connection release is registered in the log file (S1010, S1000). The log file after editing is written in the NVRAM 51d (S1020) to update the log file in the NVRAM 51d.

The configuration of the recording system 1 is explained above. According to the recording system 1, with a trigger state where the portable terminal 10 and the in-vehicle apparatus 50 are connected via the connecters CN1, CN2 to enable the data communications, the vehicle compartment environment data are written into the storage medium (NVRAM 11d, 51d). This almost signifies that at a trigger time approximately when the portable terminal 10 is brought into the vehicle compartment, the writing into the storage media is started with respect to the vehicle compartment environment data. Therefore, the recording system 1 accumulates in the storage media useful information for specifying the cause of an anomaly of the portable terminal 10 which results from the vehicle compartment environment, and provides users with the accumulated information. That is, according to the present embodiment, the data contents of the log file enable the analysis of what kind of environment in the vehicle compartment the portable terminal 10 is used. This is useful for specifying the failure or anomaly of the portable terminal 10 resulting from the vehicle compartment environment. Therefore, the recording system 1 according to the present embodiment can assist the development of warranty service of the portable terminal 10 and the development to enable the portable terminal 10 to be sufficiently durable against the vehicle compartment environment.

In respect of the warranty service, the use of the recording system 1 of the present embodiment enables statistical analysis of the relation between the vehicle compartment environment and the breakdown or failure cause of the portable terminal 10. This enables a more accurate calculation of a failure rate of the portable terminal 10 resulting from the vehicle compartment environment. Therefore, an estimate of warranty charge for the warranty service can be possible, assisting the development of the warranty service.

The warranty service having a warranty range covering the breakdown or failure due to the vehicle compartment environment may be provided as follows. When the portable terminal 10 breaks down, the log file stored in the portable terminal 10 or stored in the in-vehicle apparatus 50 into which the portable terminal 10 is attached is analyzed, enabling the determination as to whether the portable terminal 10 breaks down under the use within the warranty range, for example. When the portable terminal 10 is left in the vehicle compartment in mid summer for a long duration, for instance, to undergo the abnormal high temperature environment, the warranty is not provided. Otherwise, the warranty may be provided or guaranteed.

In addition, in respect of the development of the portable terminal 10 which is sufficiently durable against the vehicle compartment environment, the following may be referred to. The use of the recording system 1 of the present embodiment enables an analysis of the relation between the vehicle compartment environment and the failure of the portable terminal 10. Durability may be improved against the cause of the failure which occurs easily or more often, achieving the effective development of the portable terminal 10 that is durable against the vehicle compartment environment.

In particular, the connection partner's ID code is written in the log file according to the recording system 1 of the present embodiment. This enables an easy determination as to which portable terminal or in-vehicle apparatus is related with the record of the log file. Even when several portable terminals 10 of several users are connected with the in-vehicle apparatus 50, the failure cause of each portable terminal 10 can be determined accurately.

In addition, the recording system 1 of the present embodiment operates as follows. When an anomaly occurs in the portable terminal 10, the operation state of the portable terminal 10, the operation state of the in-vehicle apparatus 50, and the vehicle compartment environment are recorded in the log file. This enables the determination as to whether the breakdown of the portable terminal 10 results from the vehicle compartment environment or from the communications with the in-vehicle apparatus 50. The correspondence relation between the breakdown of the portable terminal 10 and the vehicle compartment environment can be determined more appropriately.

In addition, according to the present embodiment, the operation states of the portable terminal 10 and the in-vehicle apparatus 50 are recorded in the log files. Thus, even when the portable terminal 10 takes in a computer virus from an outside, not only the failure cause of the portable terminal 10 but also the failure cause of the in-vehicle apparatus 50 resulting from the computer virus can be determined.

That is, according to the recording system 1 of the present embodiment, the operation state of the in-vehicle apparatus 50 is recorded along with the operation state of the portable terminal 10. The failure cause resulting from the communications between the portable terminal 10 and the in-vehicle apparatus 50 can be determined.

In addition, the recording system 1 is designed to switch the write mode between the periodic write mode and the anomaly-trigger write mode. The periodic write mode causes the data volume recorded in the NVRAM 11d, 51d to increase. Thus, it has an advantage to easily enable an accurate determination of the failure cause using the large data volume. However, if a large data-volume storage media (NVRAM 11d, 51d) is not provided, there is a disadvantage to decrease a duration of storing the record. In contrast, the anomaly-trigger write mode enables an effective accumulation of the information necessary for specifying the anomaly occurrence cause in a storage media (NVRAM 11d, 51d).

In addition, according to the present embodiment, at a trigger time when the anomaly occurs in the portable terminal 10 or in the vehicle compartment environment, the present position coordinate at the trigger time is recorded in the log file. Therefore, the recording system 1 can provide a more accurate determination of the anomaly occurrence cause by estimating the environment of the portable terminal 10.

Each of the communications interfaces 23, 53 of the portable terminal 10 and the in-vehicle apparatus 50 may be also referred to as a communications means or device. Each of the temperature sensor 81, the humidity sensor 83, and the vibration sensor 85 may be also referred to as a measurement instrument or apparatus. The processing at S310, S510, S610 executed by the control circuit 11, 51 may be also referred to as a measurement data acquisition means or section. The processing at S1130, S1220 executed by the control circuit 11, 51 may be also referred to as an output means or section. The processing at S145, S160, S170 to S210, S240 to S260 executed by the control circuit 11, 51 may be also referred to as a write control means or section. In particular, the operation to “write an identification code of an apparatus serving as a connection partner in a storage media” corresponds to the operation to write the connection partner's ID code in the log file at S145.

In addition, the association between the identification code and the vehicle compartment environment may be realized by storing the data (record) indicating a vehicle compartment environment in the log file having the header information. The association between the data indicating the vehicle compartment environment and the data indicating the operation state may be realized by storing each data in the identical log file or writing the event time and date. In addition, the detection operation of the abnormal vehicle compartment environment may be achieved by comparing the threshold value Th1, Th2, Th3, or Th4, and the measurement value of the corresponding sensor. The GPS receiver 21 may be also referred to as a position detection means or device.

In addition, without need of limiting to the above embodiment, the embodiment of the present invention can be achieved in various different manners. In the above embodiment, in the anomaly-trigger write mode, during the anomaly of the vehicle compartment environment taking place (during the high temperature, high humidity, strong vibration level), the record describing the vehicle compartment environment (temperature, humidity, vibration level) is registered in the log file periodically. In contrast, in the primary recording process, such record registering operation may be stopped, whereas the record may be registered only at the start time and at the end time of the environment anomaly. That is, the primary recording process may be designed as follows. When the negative determination is made at S350, S450, the temperature information write control process may be ended without advancing to S335. The same may be applied to the humidity information write control process or the vibration information write control process. Thus, if the primary recording process is thus designed, the amount of record registration at the time of the anomaly occurrence can be reduced.

In addition, in the above embodiment, the vibration sensor 85 is mounted in the in-vehicle apparatus 50. The vibration sensor 85 is included in the portable terminal 10 in many cases. Therefore, on a premise that the portable terminal 10 is equipped with the vibration sensor 85, it may be designed that the in-vehicle apparatus 50 acquires the vibration measurement data from the portable terminal 10. In addition, the vibration sensor 85 or GPS receiver 21 may be included in both the in-vehicle apparatus 50 and the portable terminal 10. Thus, when an identical sensor or GPS receiver is included in both the in-vehicle apparatus 50 and the portable terminal 10, the recording system 1 can be designed such that a user can determine which sensor or GPS receiver is used for registering.

In addition, the above recording system 1 may be designed such that the number of times the portable terminal 10 is removed from the in-vehicle apparatus 50 is registered in the log file. According to such a recording system 1, the failure resulting from the abnormal detachment can be specified.

Each or any combination of processes, functions, sections, steps, or means explained in the above can be achieved as a software section or unit (e.g., subroutine) and/or a hardware section or unit (e.g., circuit or integrated circuit), including or not including a function of a related device; furthermore, the hardware section or unit can be constructed inside of a microcomputer.

Furthermore, the software section or unit or any combinations of multiple software sections or units can be included in a software program, which can be contained in a non-transitory computer-readable storage media or can be downloaded via a communications network and then stored in a non-transitory computer-readable storage media.

Aspects of the disclosure described herein are set out in the following clauses.

As an aspect of the disclosure, a recording system including a portable terminal and an in-vehicle apparatus is provided as follows. The portable terminal is a portable information apparatus; and the in-vehicle apparatus is mounted in a vehicle and includes a measurement data acquisition section to acquire measurement data indicating a measurement result of a physical quantity measured by a measurement instrument, the physical quantity being relative to a vehicle compartment environment of the vehicle, the vehicle compartment environment varying over time. The portable terminal and the in-vehicle apparatus respectively include communications devices which communicate with each other. At least one of the portable terminal and the in-vehicle apparatus includes a storage media and an output section. The storage media stores data indicating the vehicle compartment environment; the output section outputs the vehicle compartment environment data stored in the storage media. At least one of the portable terminal and the in-vehicle apparatus includes a write control section configured to write data indicating the vehicle compartment environment under a communications state, where the portable device and the in-vehicle apparatus are connected to enable communications, based on the measurement data acquired by the measurement data acquisition section, with an onset of connection between the portable terminal and the in-vehicle apparatus to enable the communications state via the communications devices.

As an optional aspect of the above recording system, the write control section may be configured to write data indicating the vehicle compartment environment in association with an identification code of a connection partner in the storage media included in one of the portable terminal and the in-vehicle apparatus, the connection partner being an other of the portable terminal and the in-vehicle apparatus.

The combination of the portable terminal and in-vehicle apparatus may not be one-to-one correspondence. In such a case, even if only data indicating the vehicle compartment environment is written in the storage medium, it is not easy to specify the actual combination between a portable terminal and an in-vehicle apparatus corresponding to the written data. Such a disadvantage is solvable if an identification code is associated with the data indicating the vehicle compartment environment like the write control section does.

In particular, such a configuration offers an advantage when the data indicating the vehicle compartment environment is stored in a storage media of the in-vehicle apparatus. Even in cases where several portable terminals are connected to the in-vehicle apparatus, the useful information (data indicating the vehicle compartment environment) for specifying the anomaly cause of the portable terminals is recordable, respectively, in the storage media of the in-vehicle apparatus.

As another optional aspect of the recording system, the write control section may be configured to further write in the storage media an operation state of the portable terminal, which is under the communications state where the portable terminal and the in-vehicle apparatus are connected with each other to enable communications, in association with data indicating the vehicle compartment environment.

According to this recording system, the correspondence relation between the vehicle compartment environment and the operation state of the portable terminal can be understood based on the data stored in the storage media. This enables easy specification of the cause of the anomaly in the portable terminal.

In the above configuration, the write control section may be configured to further write in the storage media an operation state of the in-vehicle apparatus, which is under the communications state where the portable terminal and the in-vehicle apparatus are connected with each other to enable communications, in association with data indicating the vehicle compartment environment.

Under the establishment of the communications between the portable terminal and in-vehicle apparatus, one of the two may affect an operation of the other serving as a communications partner. The cause of the anomaly in the portable terminal may result from the in-vehicle apparatus. According to the above configuration of the recording system, based on the data stored in the storage media, it can be easily understood from which of the in-vehicle apparatus or the vehicle compartment the cause of the anomaly in the portable terminal results. This enables easier specification of the cause of the anomaly in the portable terminal.

As another optional aspect of the recording system, the write control section may be configured to write, at periodic times for a duration under the communications state where the portable terminal and the in-vehicle apparatus are connected with each other to enable communications, data indicating the vehicle compartment environment at each of the periodic times, in the storage media.

As another optional aspect of the recording system, the write control section may be configured to detect an abnormal vehicle compartment environment that is noncompliant with a specification of the portable terminal for a duration under the communications state where the portable terminal and the in-vehicle apparatus are connected with each other to enable communications, and write an occurrence cause of the abnormal vehicle compartment environment in the storage media as data indicating the vehicle compartment environment.

When the data indicating the vehicle compartment environment is periodically (at each of periodic times) written in the storage media, the data volume written in the storage media increases. On the other hand, based on the data stored in the storage media, the vehicle compartment environment can be analyzed in details later.

When the data recording an anomaly occurrence of the vehicle compartment environment as the data indicating the vehicle compartment environment is written in the storage media, the data volume written in the storage media can be reduced, enabling the efficient writing of the data useful for specifying the cause of the anomaly occurrence of the portable terminal in the storage media. It is noted that the write control section may be provided to execute the writing of the data indicating the vehicle compartment environment using both the above modes or operations.

As another optional aspect of the recording system, the write control section may be configured to write in the storage media at least one of a temperature, a humidity, and a vibration level in a vehicle compartment of the vehicle as data indicating the vehicle compartment environment.

As another optional aspect of the recording system, the write control section may be configured to detect as the abnormal vehicle compartment environment an environment being in a vehicle compartment temperature range that is noncompliant with a specification of the portable terminal, and write, as the occurrence cause of the abnormal vehicle compartment environment, a duration for which a vehicle compartment temperature is in the vehicle compartment temperature range that is noncompliant with the specification of the portable terminal, in the storage media.

As another optional aspect of the recording system, the write control section may be configured to detect as the abnormal vehicle compartment environment an environment being in a vehicle compartment humidity range that is noncompliant with a specification of the portable terminal, and write, as the occurrence cause of the abnormal vehicle compartment environment, a duration for which a vehicle compartment humidity is in the vehicle compartment humidity range that is noncompliant with the specification of the portable terminal, in the storage media.

As another optional aspect of the recording system, the write control section may be configured to detect as the abnormal vehicle compartment environment an environment being in a vehicle compartment vibration level range that is noncompliant with a specification of the portable terminal, and write, as the occurrence cause of the abnormal vehicle compartment environment, a duration for which a vehicle compartment vibration level is in the vehicle compartment vibration level range that is noncompliant with the specification of the portable terminal, in the storage media.

As another optional aspect of the recording system, the write control section may be configured to write, at each of periodical times for a duration under the communications state where the portable terminal and the in-vehicle apparatus are connected to enable communications, data indicating an operation state of the portable terminal at the each of the periodic times in association with data indicating the vehicle compartment environment at the each of the periodic times in the storage media.

As another optional aspect of the recording system, the write control section may be configured to detect an abnormal vehicle compartment environment noncompliant with a specification of the portable terminal for a duration under the communications state where the portable terminal and the in-vehicle apparatus are connected with each other to enable communications, and write, with an onset of detecting the abnormal vehicle compartment environment, data indicating an operation state of the portable terminal at an occurrence time of the abnormal vehicle compartment environment in association with data indicating the vehicle compartment environment at the occurrence time of the abnormal vehicle compartment environment, in the storage media.

As another optional aspect of the recording system, the write control section may be configured to further write, at each of periodic times for the duration under the communications state where the portable terminal and the in-vehicle apparatus are connected to enable communications, data indicating an operation state of the in-vehicle apparatus at the each of the periodic times, in association with data indicating the vehicle compartment environment in the storage media.

As another optional aspect of the recording system, the write control section may be configured to further write, in the storage media, data indicating an operation state of the in-vehicle apparatus at the occurrence time of the abnormal vehicle compartment environment in association with the data indicating the vehicle compartment environment at the occurrence time of the abnormal vehicle compartment environment, with the onset of detecting the abnormal vehicle compartment environment.

As another optional aspect of the recording system, the write control section may be configured to write, each time detecting an anomaly in the portable terminal for a duration under the communications state where the portable terminal and the in-vehicle apparatus are connected to enable communications, data indicating an operation state of the portable terminal at an occurrence time of the abnormal vehicle compartment environment in association with data indicating the vehicle compartment environment in the storage media.

As another optional aspect of the recording system, the write control section may be configured to write, each time detecting an anomaly in the portable terminal for a duration under the communications state where the portable terminal and the in-vehicle apparatus are connected to enable communications, data indicating an operation state of the portable terminal and an operation state of the in-vehicle apparatus at an occurrence time of the abnormal vehicle compartment environment in association with data indicating the vehicle compartment environment in the storage media.

As another optional aspect of the recording system, the write control section may be configured to write data indicating a vehicle compartment environment in association with data indicating an occurrence time and date of the vehicle compartment environment in the storage media.

As another optional aspect of the recording system, the write control section may be configured to write data indicating an operation state in association with data indicating an occurrence time and date of the operation state in the storage media.

As another optional aspect of the recording system, a position detection device may be included in at least one of the portable terminal and the in-vehicle apparatus to detect a present position of the at lease one of the portable terminal and the in-vehicle apparatus. The write control section may be configured to write data on position at which the at least one of the portable terminal and the in-vehicle apparatus is located at a clock time corresponding to data indicating an vehicle compartment environment in association with the data indicating the vehicle compartment environment in the storage media, based on a detection result of the position detection device.

As another optional aspect of the recording system, the write control section may be configured to write a time and date of a start of a connection between the portable terminal and the in-vehicle apparatus and a time and date of a release of the connection between the portable terminal and the in-vehicle apparatus.

It will be obvious to those skilled in the art that various changes may be made in the above-described embodiments of the present invention. However, the scope of the present invention should be determined by the following claims.

What is claimed:

1. A recording system comprising:
a portable terminal that is a portable information apparatus; and
an in-vehicle apparatus mounted in a vehicle and including a measurement data acquisition section to acquire measurement data indicating a measurement result of a physical quantity measured by a measurement instrument, the physical quantity being relative to a vehicle compartment environment of the vehicle, the vehicle compartment environment varying over time,
the portable terminal and the in-vehicle apparatus respectively including communications devices which communicate with each other,
at least one of the portable terminal and the in-vehicle apparatus comprising:
a storage media and an output section,
the storage media that stores data indicating the vehicle compartment environment,
the output section that outputs the vehicle compartment environment data stored in the storage media,
at least one of the portable terminal and the in-vehicle apparatus comprising:
a write control section configured to write data indicating the vehicle compartment environment under a communications state, where the portable device and the in-vehicle apparatus are connected to enable communications, based on the measurement data acquired by the measurement data acquisition section, with an onset of connection between the portable terminal and the in-vehicle apparatus to enable the communications state via the communications devices.

2. The recording system 1 according to claim 1,
the write control section being configured to write data indicating the vehicle compartment environment in association with an identification code of a connection partner in the storage media included in one of the portable terminal and the in-vehicle apparatus, the connection partner being an other of the portable terminal and the in-vehicle apparatus.

3. The recording system according to claim 1,
the write control section being configured to further write in the storage media an operation state of the portable terminal, which is under the communications state where the portable terminal and the in-vehicle apparatus are connected with each other to enable communications, in association with data indicating the vehicle compartment environment.

4. The recording system according to claim 3,
the write control section being configured to further write in the storage media an operation state of the in-vehicle apparatus, which is under the communications state where the portable terminal and the in-vehicle apparatus are connected with each other to enable communications, in association with data indicating the vehicle compartment environment.

5. The recording system according to claim 1,
the write control section being configured to write, at periodic times for a duration under the communications state where the portable terminal and the in-vehicle apparatus are connected with each other to enable communications, data indicating the vehicle compartment environment at each of the periodic times, in the storage media.

6. The recording system according to claim 1,
the write control section being configured to write in the storage media at least one of a temperature, a humidity, and a vibration level in a vehicle compartment of the vehicle as data indicating the vehicle compartment environment.

7. The recording system according to claim 1,
the write control section being configured to
detect an abnormal vehicle compartment environment that is noncompliant with a specification of the portable terminal for a duration under the communications state where the portable terminal and the in-vehicle apparatus are connected with each other to enable communications, and
write an occurrence cause of the abnormal vehicle compartment environment in the storage media as data indicating the vehicle compartment environment.

8. The recording system according to claim 7,
the write control section being configured to
detect as the abnormal vehicle compartment environment an environment being in a vehicle compartment temperature range that is noncompliant with a specification of the portable terminal, and
write, as the occurrence cause of the abnormal vehicle compartment environment, a duration for which a vehicle compartment temperature is in the vehicle compartment temperature range that is noncompliant with the specification of the portable terminal, in the storage media.

9. The recording system according to claim 7,
the write control section being configured to
detect as the abnormal vehicle compartment environment an environment being in a vehicle compartment humidity range that is noncompliant with a specification of the portable terminal, and
write, as the occurrence cause of the abnormal vehicle compartment environment, a duration for which a vehicle compartment humidity is in the vehicle compartment humidity range that is noncompliant with the specification of the portable terminal, in the storage media.

10. The recording system according to claim 7,
the write control section being configured to
detect as the abnormal vehicle compartment environment an environment being in a vehicle compartment vibration level range that is noncompliant with a specification of the portable terminal, and
write, as the occurrence cause of the abnormal vehicle compartment environment, a duration for which a vehicle compartment vibration level is in the vehicle compartment vibration level range that is noncompliant with the specification of the portable terminal, in the storage media.

11. The recording system according to claim 3,
the write control section being configured to
detect an abnormal vehicle compartment environment noncompliant with a specification of the portable terminal for a duration under the communications state where the portable terminal and the in-vehicle apparatus are connected with each other to enable communications, and
write, with an onset of detecting the abnormal vehicle compartment environment, data indicating an operation state of the portable terminal at an occurrence time of the abnormal vehicle compartment environment in association with data indicating the vehicle compartment environment at the occurrence time of the abnormal vehicle compartment environment, in the storage media.

12. The recording system according to claim 11,
the write control section being configured to further write, in the storage media, data indicating an operation state of the in-vehicle apparatus at the occurrence time of the abnormal vehicle compartment environment in association with the data indicating the vehicle compartment environment at the occurrence time of the abnormal vehicle compartment environment, with the onset of detecting the abnormal vehicle compartment environment.

13. The recording system according to claim 3,
the write control section being configured to write, each time detecting an anomaly in the portable terminal for a duration under the communications state where the portable terminal and the in-vehicle apparatus are connected to enable communications, data indicating an operation state of the portable terminal at an occurrence time of the abnormal vehicle compartment environment in association with data indicating the vehicle compartment environment in the storage media.

14. The recording system according to claim 13,
the write control section being configured to write, each time detecting an anomaly in the portable terminal for a duration under the communications state where the portable terminal and the in-vehicle apparatus are connected to enable communications, data indicating an operation state of the portable terminal and an operation state of the in-vehicle apparatus at an occurrence time of the abnormal vehicle compartment environment in association with data indicating the vehicle compartment environment in the storage media.

15. The recording system according to claim 3,
the write control section being configured to write, at each of periodical times for a duration under the communications state where the portable terminal and the in-vehicle apparatus are connected to enable communications, data indicating an operation state of the portable terminal at the each of the periodic times in association with data indicating the vehicle compartment environment at the each of the periodic times in the storage media.

16. The recording system according to claim 15,
the write control section being configured to further write, at each of periodic times for the duration under the communications state where the portable terminal and the in-vehicle apparatus are connected to enable communications, data indicating an operation state of the in-vehicle apparatus at the each of the periodic times, in association with data indicating the vehicle compartment environment in the storage media.

17. The recording system according to claim 1,
the write control section being configured to write data indicating a vehicle compartment environment in association with data indicating an occurrence time and date of the vehicle compartment environment in the storage media.

18. The recording system according to claim 3,
the write control section being configured to write data indicating an operation state in association with data indicating an occurrence time and date of the operation state in the storage media.

19. The recording system according to claim 1, further comprising
a position detection device included in at least one of the portable terminal and the in-vehicle apparatus to detect a present position of the at lease one of the portable terminal and the in-vehicle apparatus,
the write control section being configured to write data on position at which the at least one of the portable terminal and the in-vehicle apparatus is located at a clock time corresponding to data indicating an vehicle compartment environment in association with the data indicating the vehicle compartment environment in the storage media, based on a detection result of the position detection device.

20. The recording system according to claim 1,
the write control section being configured to write a time and date of a start of a connection between the portable terminal and the in-vehicle apparatus and a time and date of a release of the connection between the portable terminal and the in-vehicle apparatus.

21. An in-vehicle apparatus mounted in a vehicle, the apparatus comprising:
a storage media;
a communications device configured to connect with a portable terminal in a vehicle compartment of the vehicle to enable wired or wireless communications;
a measurement data acquisition section configured to acquire measurement data indicating a measurement result of a physical quantity measured by a measurement instrument, the physical quantity being relative to the vehicle compartment environment that varies over time;
a write control section configured to write in the storage media data indicating the vehicle compartment environment under a communications state of connecting with the portable terminal to enable communications based on the measurement data acquired by the measurement data acquisition section with an onset of connection with the portable terminal via the communications device; and
an output section configured to output data indicating the vehicle compartment environment stored in the storage media.

22. The in-vehicle apparatus according to claim 21,
the write control section being configured to
acquire an identification code of the portable terminal serving as a connection partner via the communications device, and
write in the storage media the acquired identification code in association with data indicating the vehicle compartment environment.

23. The in-vehicle apparatus according to claim 21,
the write control section being configured to
acquire an operation state of the portable terminal via the communications device under the communications state of connecting with the portable terminal to enable communications, and
write the acquired operation state of the portable terminal in association with data indicating the vehicle compartment environment in the storage media.

24. The in-vehicle apparatus according to claim 23,
the write control section being configured to further write in the storage media an operation state of the in-vehicle apparatus itself under the communications state where the portable terminal and the in-vehicle apparatus are connected with each other to enable communications, in association with data indicating the vehicle compartment environment.

25. A portable terminal cooperating an in-vehicle apparatus mounted in a vehicle,
the portable terminal comprising:
a communications device configured to establish in a vehicle compartment of the vehicle a communications state of connecting with the in-vehicle apparatus to enable wired or wireless communications;
a write control section configured to
acquire, from the in-vehicle apparatus, measurement data indicating a measurement result of a physical quantity measured by a measurement instrument, the physical quantity being relative to a vehicle compartment environment that varies over time, via the communications device with an onset of the communications state of connecting with the in-vehicle apparatus via the communications device, and
write, based on the acquired measurement data, data indicating a vehicle compartment environment under the communications state of connecting with the in-vehicle apparatus in the storage media; and
an output section configured to output data indicating the vehicle compartment environment stored in the storage media.

26. The portable terminal according to claim 25,
the write control section being configured to
acquire an identification code of the in-vehicle apparatus serving as a connection partner via the communications device, and
write in the storage media the acquired identification code in association with the data indicating the vehicle compartment environment.

27. The portable terminal according to claim 26,
the write control section being configured to further write in the storage media an operation state of the portable terminal itself under the communications state of connecting with the in-vehicle apparatus, in association with the data indicating the vehicle compartment environment.

28. The portable terminal according to claim 27,
the write control section being configured to
acquire an operation state of the in-vehicle apparatus via the communications device under the communications state of connecting with the in-vehicle apparatus, and
write the acquired operation state of the in-vehicle apparatus in association with the data indicating the vehicle compartment environment in the storage media.

29. The recording system according to claim 7,
wherein the specification of the portable terminal is previously stored in a storage media included in the portable terminal,
the write control section being configured to compare the specification stored in the storage media in the portable terminal with the measurement data acquired by the measurement data acquisition section in the in-vehicle apparatus, detecting the abnormal vehicle compartment environment.

30. The recording system according to claim 11,
wherein the specification of the portable terminal is previously stored in a storage media included in the portable terminal,
the write control section being configured to compare the specification stored in the storage media in the portable terminal with the measurement data acquired by the measurement data acquisition section in the in-vehicle apparatus, detecting the abnormal vehicle compartment environment.
